(19) United States
(12) Patent Application Publication
(10) Pub. No.: US 2026/0131834 A1
(43) Pub. Date: May 14, 2026

(54) APPARATUS AND METHOD FOR MEASURING IRREGULARITY OF PERMANENT MAGNET TRACK

(71) Applicant: SOUTHWEST JIAOTONG UNIVERSITY, Chengdu (CN)

(72) Inventors: Zigang DENG, Chengdu (CN); Li WANG, Chengdu (CN); Yan LI, Chengdu (CN); Yi LUO, Chengdu (CN); Xucheng ZHOU, Chengdu (CN)

(73) Assignee: SOUTHWEST JIAOTONG UNIVERSITY, Chengdu (CN)

(21) Appl. No.: 19/359,755

(22) Filed: Oct. 16, 2025

Related U.S. Application Data
(63) Continuation of application No. PCT/CN2025/101357, filed on Jun. 17, 2025.

(30) Foreign Application Priority Data
Nov. 13, 2024 (CN) 202411613122.8

(51) Int. Cl. B61K 9/08; G01B 21/30

(52) U.S. Cl. CPC B61K 9/08; G01B 21/30

(57) ABSTRACT

The provided is an apparatus and a method for measuring irregularity of a permanent magnet track. The apparatus includes: a superconducting levitator; a Hall sensor assembly is arranged on the superconducting levitator, one end of the Hall sensor assembly extends toward the permanent magnet track to form a positioning end, a plurality of Hall sensors uniformly arranged at the same interval distance along a width direction of the permanent magnet track are arranged on the positioning end, and the plurality of Hall sensors and a bottom of a superconductor in the superconducting levitator are all positioned on the same horizontal plane; an acceleration detection apparatus is arranged on the superconducting levitator, the acceleration detection apparatus is arranged along a length direction of the permanent magnet track, and one end of the acceleration detection apparatus extends toward the permanent magnet track to form a measuring end.

### CROSS-REFERENCE TO THE RELATED APPLICATIONS

This application is a continuation application of International Application No. PCT/CN2025/101357, filed on Jun. 17, 2025, which is based upon and claims priority to Chinese Patent Application No. 202411613122.8, filed on Nov. 13, 2024, the entire contents of which are incorporated herein by reference.

### TECHNICAL FIELD

The present application relates to the technical field of permanent magnet track detection, and specifically to an apparatus and a method for measuring irregularity of a permanent magnet track.

### BACKGROUND

In the field of permanent magnet track detection technology, a vehicle frame and detection device are usually provided. The detection device is mostly fixed on the vehicle frame and moves along the permanent magnet track with the vehicle frame for detection. However, the current design is limited by the installation position and angle of the detection device, which has certain limitations and cannot fully cover all detection directions, resulting in the difficulty of measuring data to meet high-precision requirements and the inability to make accurate judgments on the health status of the permanent magnet track. Therefore, there is an urgent need for an apparatus and a method for measuring irregularity of a permanent magnet track, which solves the problem that the existing technology cannot fully cover all detection directions, resulting in the measurement data being difficult to meet high-precision requirements and unable to make an accurate judgment on the health status of the permanent magnet track.

### SUMMARY

An objective of the present application aims to provide an apparatus and a method for measuring irregularity of a permanent magnet track, so as to improve the problems. To achieve the above objective, the present application adopts the following technical solutions.

According to a first aspect, the present application provides an apparatus for measuring irregularity of a permanent magnet track, which includes:

a superconducting levitator, where a Hall sensor assembly is arranged on the superconducting levitator, one end of the Hall sensor assembly extends toward the permanent magnet track to form a positioning end, a plurality of Hall sensors uniformly arranged at the same interval distance along a width direction of the permanent magnet track are arranged on the positioning end, and the plurality of Hall sensors and a bottom of a superconductor in the superconducting levitator are all positioned on the same horizontal plane; an acceleration detection apparatus is arranged on the superconducting levitator, the acceleration detection apparatus is arranged along a length direction of the permanent magnet track, one end of the acceleration detection apparatus extends toward the permanent magnet track to form a measuring end, and a height of the measuring end of the acceleration detection apparatus is consistent with that of a center of mass of the superconducting levitator.

According to a second aspect, the present application further provides a method for measuring irregularity of a permanent magnet track, which includes: collecting a time domain signal of a superconducting levitator during operation based on a Hall sensor assembly, an acceleration detection apparatus and a photoelectric sensor, where the time domain signal includes a photoelectric signal, an acceleration time domain signal, and a magnetic field time domain signal;
processing the photoelectric signal based on a preset peak-finding method to obtain time-course information of each peak and trough;
fitting the time-course information of peaks and troughs to obtain a real-time speed of the superconducting levitator (1);
converting the acceleration time domain signal and the magnetic field time domain signal according to the real-time speed of the superconducting levitator to obtain a spatial domain signal;
constructing the spatial domain signal and a preset magnetic position signal according to a preset Fourier integration method to obtain an equivalent geometric irregularity signal; and
performing spectral density fitting on the equivalent geometric irregularity signal according to a preset Fourier variation method to obtain an equivalent geometric irregularity fitting parameter of the permanent magnet track.

According to a third aspect, the present application further provides a device for measuring irregularity of a permanent magnet track, which includes:
a memory, configured to store a computer program; and
a processor, configured to implement the steps in the method for measuring irregularity of the permanent magnet track when executing the computer program.

In a fourth aspect, the present application further provides a readable storage medium, on which a computer program is stored, where the computer program, when being executed by a processor, implements the steps in the method for measuring irregularity of the permanent magnet track.

The beneficial effects of the present application are as follows.

The present application introduces a Hall sensor assembly and an acceleration detection apparatus, where the Hall sensor assembly and the acceleration detection apparatus are both arranged on the superconducting levitator, and the Hall sensor is configured to acquire a magnetic field time domain signal, so that the problems that the coverage area is small and two-dimensional position positioning cannot be performed in the prior art are solved. A height of the measuring end of the acceleration detection apparatus is consistent with that of a center of mass of the superconducting levitator, the acceleration detection apparatus is configured to acquire an acceleration time domain signal, and the problem of the influence of the rolling and shaking motion of the superconducting levitator on the acceleration time domain signal in the prior art is solved. The Hall sensor assembly, the acceleration detection apparatus and the superconducting levitator are arranged together, so that the problem that the existing technology cannot fully cover all detection directions, resulting in the measurement data being difficult to meet high-precision requirements and unable to make an accurate judgment on the health status of the permanent magnet track is solved.

Other features and advantages of the present application will be set forth in the specification below, and will be partly apparent from the specification or may be understood by implementing embodiments of the present application. The objectives and other advantages of the present application may be achieved and obtained through the structures particularly pointed out in the written specification, claims, and drawings.

### BRIEF DESCRIPTION OF THE DRAWINGS

To describe the technical solutions in examples of the present application more clearly, the following briefly describes the accompanying drawings used for describing examples. It should be understood that the accompanying drawings show only some examples of the present application, and therefore should not be considered as a limitation on the scope. Those of ordinary skill in the art may still derive other related drawings from these accompanying drawings without creative efforts.

FIG. 1 is a schematic front view of an apparatus for measuring irregularity of a permanent magnet track according to an embodiment of the present application;

FIG. 2 is a schematic perspective view of an apparatus for measuring irregularity of a permanent magnet track according to an embodiment of the present application;

FIG. 3 is a schematic right view of an apparatus for measuring irregularity of a permanent magnet track according to an embodiment of the present application;

FIG. 4 is a schematic flow chart of a method for measuring irregularity of a permanent magnet track according to an embodiment of the present application;

FIG. 5 is a peak-trough value of a photoelectric sensor measurement signal and a peak-finding algorithm identified in an embodiment of the present application; and

FIG. 6 is a schematic structural diagram of a device for measuring irregularity of a permanent magnet track according to an embodiment of the present application.

Reference numerals: 1. superconducting levitator; 2. permanent magnet track; 3. Hall sensor assembly; 4. acceleration detection apparatus; 5. photoelectric sensor; 6. data acquisition card; 41. first acceleration sensor; 42. second acceleration sensor; 800. permanent magnet track irregularity measuring device; 801. processor; 802. memory; 803. multimedia component; 804. I/O interface; and 805. communication component.

### DETAILED DESCRIPTION OF THE EMBODIMENTS

To make objectives, technical solutions, and advantages of embodiments of the present application clearer, the following clearly and completely describes the technical solutions in embodiments of the present application with reference to the accompanying drawings in embodiments of the present application. It is clear that the described embodiments are some but not all of embodiments of the present application. Generally, components of embodiments of the present application described and shown in the accompanying drawings herein may be arranged and designed in various configurations. Therefore, the following detailed descriptions of embodiments of the present application provided in the accompanying drawings are not intended to limit the scope of the present application that claims protection, but merely to represent selected embodiments of the present application. Based on the embodiments of the present application, all other embodiments obtained by those of ordinary skill in the art without creative effort fall within the protection scope of the present application.

It should be noted that similar reference numerals and letters indicate similar items in the following drawings, and therefore, once an item is defined in one of the drawings, no further definition or explanation is required in the following drawings. Meanwhile, in the description of the present application, the terms “first”, “second” and the like are used only for distinguishing the description, and may not be construed as indicating or implying the relative importance.

### Embodiment 1

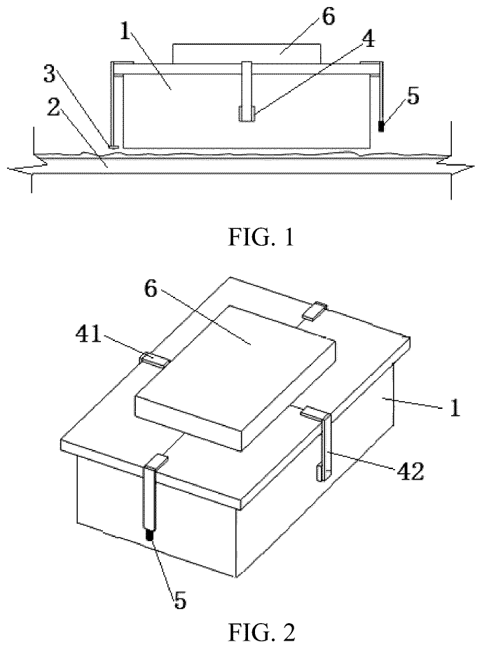

As shown in FIGS. 1 and 2, this embodiment provides an apparatus for measuring irregularity of a permanent magnet track, where the apparatus includes a superconducting levitator 1, a Hall sensor assembly 3 is arranged on the superconducting levitator 1, one end of the Hall sensor assembly 3 extends toward the permanent magnet track 2 to form a positioning end, a plurality of Hall sensors 31 uniformly arranged at the same interval distance along a width direction of the permanent magnet track 2 are arranged on the positioning end, and the plurality of Hall sensors 31 and a bottom of a superconductor in the superconducting levitator 1 are all positioned on the same horizontal plane; an acceleration detection apparatus 4 is arranged on the superconducting levitator 1, the acceleration detection apparatus 4 is arranged along a length direction of the permanent magnet track 2, one end of the acceleration detection apparatus 4 extends toward the permanent magnet track 2 to form a measuring end, and a height of the measuring end of the acceleration detection apparatus 4 is consistent with that of a center of mass of the superconducting levitator 1.

The specific process of this apparatus is as follows: an optical target is laid on the permanent magnet track 2, the superconducting levitator 1 is arranged on the permanent magnet track 2 through a pad, nitrogen liquid is injected into the superconducting levitator 1, and the pad is withdrawn after the superconductor inside the superconducting levitator 1 is completely cooled to a superconducting state, so that the superconducting levitator 1 is in a free levitation state, the superconducting levitator 1 adjusts the levitation height through the pads of different corresponding thicknesses, and the Hall sensor assembly 3 and the acceleration detection apparatus 4 measure the specific parameters of the permanent magnet track 2 through the different levitation heights of the superconducting levitator 1.

The Hall sensor assembly 3 is configured to acquire a magnetic field time domain signal, and the Hall sensor assembly 3 is configured to perform two-dimensional position positioning on the permanent magnet track 2 and accurately measure the position information change corresponding to the actual magnetic field change. The acceleration detection apparatus 4 solves the problem of the influence of the rolling and shaking motion of the superconducting levitator on the acceleration time domain signal in the prior art.

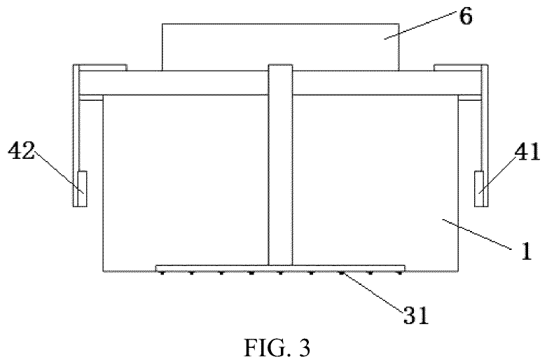

As shown in FIG. 3, a plurality of acceleration detection apparatuses 4 include a first acceleration sensor 41 and a second acceleration sensor 42, the first acceleration sensor 41 and the second acceleration sensor 42 are arranged on a side surface of the superconducting levitator 1 by a clamp, and the first acceleration sensor 41 is arranged opposite to the second acceleration sensor 42 in the width direction of the permanent magnet track 2.

In this structure, the first acceleration sensor 41 and the second acceleration sensor 42 are configured to acquire acceleration time domain signals. Preferably, the first acceleration sensor 41 and the second acceleration sensor 42 are both triaxial acceleration sensors.

To specify the specific structure of the superconducting levitator 1, the superconducting levitator 1 is provided with a photoelectric sensor 5, the photoelectric sensor 5 is arranged on a side surface of the superconducting levitator 1 far away from the Hall sensor assemblies 3 by a clamp, and the photoelectric sensor 5 is arranged opposite to the plurality of Hall sensor assemblies 3 along a length direction of the permanent magnet track 2.

The photoelectric sensor 5 is configured to acquire a photoelectric signal, and the photoelectric sensor 5 performs speed measurement and positioning on the superconducting levitator 1 and the permanent magnet track 2 by using an optical target method. Preferably, the photoelectric sensor 5 is a diffuse reflection photoelectric sensor.

In this structure, a data acquisition card 6 is arranged at a top of the superconducting levitator 1, and the data acquisition card 6 is electrically connected to the first acceleration sensor 41, the second acceleration sensor 42, the plurality of Hall sensor assemblies 3, and the photoelectric sensor 5. The data acquisition card 6 is configured to synchronize the photoelectric signal, the acceleration time domain signal, and the magnetic field time domain signal.

It should be noted that, regarding the apparatus in the above embodiment, the specific manner in which each module performs the operation has been described in detail in the embodiment of the method. Details are not described herein again.

### Embodiment 2

This embodiment provides a method for measuring irregularity of a permanent magnet track.

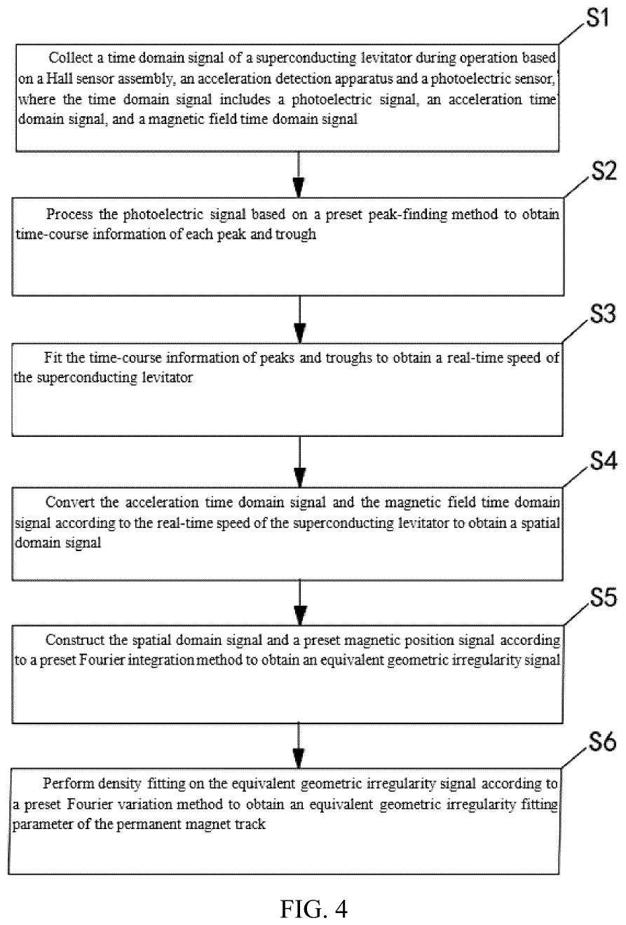

FIG. 4 shows this method, which includes steps S1 to S6, specifically:

S1: A time domain signal of a superconducting levitator 1 during operation is collected based on a Hall sensor assembly 3, an acceleration detection apparatus 4 and a photoelectric sensor 5, where the time domain signal includes a photoelectric signal, an acceleration time domain signal, and a magnetic field time domain signal.

S2: The photoelectric signal is precessed based on a preset peak-finding method to obtain time-course information of peaks and troughs.

To specify the specific manner of obtaining the time-course information of peaks and troughs, the step S2 includes S21 to S23, specifically:

S21: Performing low-pass filtering and noise reduction processing on the photoelectric signal to obtain a noise-reduced photoelectric signal;

S22: Performing peak finding processing on the noise-reduced photoelectric signal based on a preset multi-window spectrum peak recognition algorithm to obtain a plurality of highest peaks and a plurality of lowest peaks; where

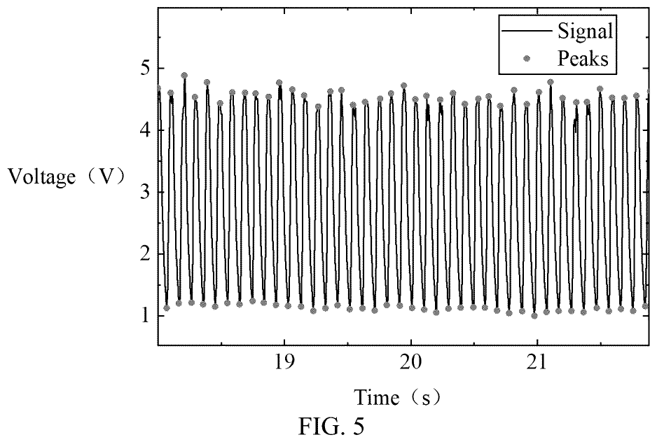

in this step, referring to FIG. 5, the plurality of highest peaks and the plurality of lowest peaks are checked;

S23: Obtaining time-course information of each peak and trough by construction according to the plurality of highest peaks and the plurality of lowest peaks.

S3: The time-course information of peaks and troughs is fitted to obtain a real-time speed of the superconducting levitator (1).

To specify a specific manner of obtaining the real-time speed of the superconducting levitator 1, the step S3 includes S31 to S34, specifically:
S31: Arranging a plurality of ground optical targets on the permanent magnet track 2, and measuring the distance between the plurality of ground optical targets to obtain the spacing value between the ground optical targets; where
the spacing value of the ground optical targets is Δx; preferably, Δx=8.75 cm.
S32: Extracting the time course information of each peak and trough to obtain a running distance corresponding to a peak point;
in this step, the running distance corresponding to the peak point is nΔx.
S33: Fitting according to the spacing value of the ground optical target and the running distance corresponding to the peak point to obtain a polynomial fitting function; where in this step, the polynomial fitting function is:

$$s = A {t}^{3} + B {t}^{2} + Ct \qquad ( 1 )$$

in the above formula (1), s represents the distance, A, B [symbol] C represent the fitting parameters, and t represents the time.
S34: Performing derivation on the polynomial fitting function to obtain the real-time speed of the superconducting levitator (1); where
in this step, the real-time speed of the superconducting levitator 1 is:

$$v = 3 A {t}^{2} + 2 B t + C \qquad ( 2 )$$

in the above formula (2), v represents the speed, A, B and C represent the fitting parameters, and t represents the time.

S4: The acceleration time domain signal and the magnetic field time domain signal are converted according to the real-time speed of the superconducting levitator 1 to obtain a spatial domain signal.

S5: The spatial domain signal and a preset magnetic position signal are constructed according to a preset Fourier integration method to obtain an equivalent geometric irregularity signal;
in this step, the magnetic position signal is position information obtained by detecting a change in a magnetic field; the preset magnetic position signals are preset magnetic position signals in different directions.

To specify the specific manner of obtaining the equivalent geometric irregularity signal, the step S5 includes S51 to S55, specifically:

S51: Detecting the superconducting levitator 1 based on a first acceleration sensor 41 and a second acceleration sensor 42 to obtain a first vector signal and a second vector signal; where
in this step, the first vector signal is a₁, and the second vector signal is a₂.

S52: Constructing based on the first vector signal and the second vector signal to obtain a center of mass acceleration signal expression; where
in this step, the center of mass acceleration signal expression is:

$$a c = {a}_{1} + {a}_{2} \qquad ( 3 )$$

in the above formula (3), ac represents the center of mass acceleration signal, a₁ represents the first vector signal, and a₂ represents the second vector signal.

S53: Detecting the superconducting levitator 1 through a Hall sensor 31 to obtain a magnetic field signal value; where
in this step, the magnetic field signal value is M measurement.

S54: Constructing according to the magnetic field signal value and preset magnetic position signals in different directions to obtain an absolute displacement signal; where
to specify the specific manner of obtaining the absolute displacement signal, the step S54 includes steps S541 to S543, specifically:

S541: Constructing according to the magnetic field signal value and a preset theoretical magnetic field value to obtain a magnetic field variance expression; where
in this step, the magnetic field variance expression is:

$$\sum {( {M}_{m e a s u r e m e n t} - {M}_{c a l c u l a t i o n} ( y , z ) )}^{2} \qquad ( 4 )$$

in the above formula (4), Mₘₑₐₛᵤᵣₑₘₑₙₜ represents the magnetic field signal value, M_{calculation} represents the theoretical magnetic field value, and (y, z) represents the magnetic position signal.

S542: Extracting the magnetic field variance expression based on a preset constraint threshold value to obtain magnetic position signals in different directions; where

in this step, the preset magnetic position signals in different directions include a transverse magnetic position and a vertical magnetic position; preferably, the transverse magnetic position is y=[−15:0.1:15] mm, and the vertical magnetic position is z=[0:0.1:20] mm.

S543: Constructing the center of mass acceleration signal expression and the magnetic position signals in different directions based on a preset Fourier integration method to obtain an absolute displacement signal.

S55: Constructing the preset magnetic position signals in different directions based on the absolute displacement signal and the spatial domain signal to obtain an equivalent geometric irregularity signal.

To specify the specific method of obtaining the equivalent geometric irregularity signal, the step S55 includes S551 to S553, specifically:

S551: Constructing the transverse magnetic position according to the absolute displacement signal and the spatial domain signal to obtain a transverse irregularity signal expression; where
in this step, the transverse irregularity signal expression is:

$${S}_{y} = {X}_{y} - y \qquad ( 5 )$$

in the above formula (5), Sy represents the transverse irregularity signal, X_{y} represents the transverse position target value, and y represents the transverse magnetic position.

S552: Constructing the vertical magnetic position according to the absolute displacement signal and the spatial domain signal to obtain a vertical irregularity signal expression; where
in this step, the vertical irregularity signal expression is:

$${S}_{z} = {X}_{z} - z \qquad ( 6 )$$

in the above formula (6), S_{z} represents the vertical irregularity signal, X_{z} represents the vertical position target value, and z represents the vertical magnetic position.

S553: Constructing according to the transverse irregularity signal expression and the vertical irregularity signal expression to obtain the equivalent geometric irregularity signal.

S6: Spectral density fitting is performed on the equivalent geometric irregularity signal according to a preset Fourier variation method to obtain an equivalent geometric irregularity fitting parameter of the permanent magnet track 2.

To specify the specific manner of obtaining the equivalent geometric irregularity fitting parameter of the permanent magnet track 2, the step S6 includes S61 to S64, specifically:
S61: Performing Fourier transform on the transverse irregularity signal expression to obtain a transverse equivalent geometric irregularity power spectral density;
S62: Performing Fourier transform on the vertical irregularity signal expression to obtain a vertical equivalent geometric irregularity power spectral density;
S63: Converting the transverse equivalent geometric irregularity power spectral density and the vertical equivalent geometric irregularity power spectral density based on a preset polynomial algorithm to obtain a fitted function of an equivalent geometric irregularity spatial domain power spectral density; where
in this step, the fitted function of the equivalent geometric irregularity spatial domain power spectral density is:

$${S}_{v} ( F ) = \frac{1}{A {F}^{2} + B {F}^{3} + C {F}^{4}} \qquad ( 7 )$$

in the above formula (7), Sᵥ represents the power spectral density of the irregular spatial domain, F represents the spatial frequency, and A, B and C represents the fitting parameters.

S64: Fitting the fitted function of the equivalent geometric irregularity spatial domain power spectral density according to a preset orthogonal distance regression method to obtain an equivalent geometric irregularity fitting parameter of the permanent magnet track 2.

As shown in Table 1, in this step, the equivalent geometric irregularity fitting parameters of the vertical permanent magnet track 2 are A=14.45, B=−23.62, and C=14.07;

the equivalent geometric irregularity fitting parameters of the transverse permanent magnet track 2 are A=3.89, B=−20.86, and C=151.17.

TABLE 1
Equivalent geometric irregularity fitting
parameters of permanent magnet track

| | A | B | C |
|---|---|---|---|
| Vertical | 14.45 | −23.62 | 14.07 |
| Transverse | 3.89 | −20.86 | 151.17 |

### Embodiment 3

Corresponding to the foregoing method embodiment, this embodiment further provides a device for measuring irregularity of a permanent magnet track, and the device for measuring irregularity of the permanent magnet track described below and the method for measuring irregularity of the permanent magnet track described above may be referred to in correspondence.

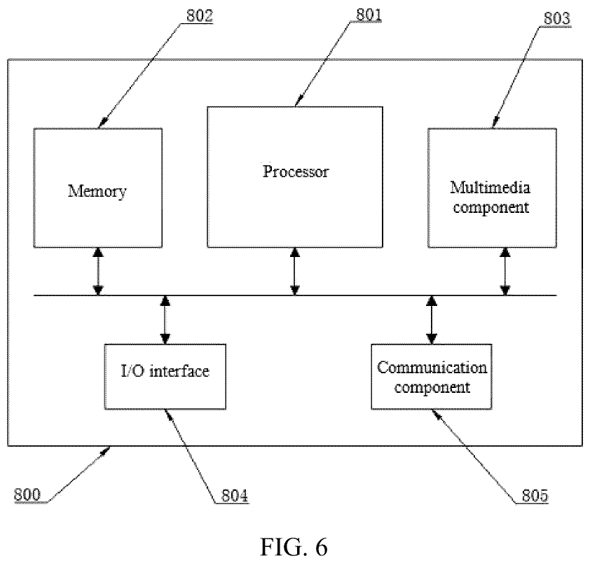

FIG. 6 is a block diagram of a permanent magnet track irregularity measuring device 800 according to an exemplary embodiment. As shown in FIG. 6, the permanent magnet track irregularity measuring device 800 may include: a processor 801, and a memory 802. The permanent magnet track irregularity measuring device 800 may further include one or more of a multimedia component 803, an I/O interface 804, and a communication component 805.

The processor 801 is configured to control the overall operation of the permanent magnet track irregularity measuring device 800, so as to complete all or part of the steps of the method for measuring irregularity of the permanent magnet track. The memory 802 is configured to store various types of data to support the operation of the permanent magnet track irregularity measuring device 800. These data may include, for example, instructions for any application or method operating on the permanent magnet track irregularity measuring device 800, as well as application-related data, such as contact data, messaging, pictures, audio, and video. The memory 802 may be implemented by any type of volatile or nonvolatile storage device or a combination thereof, such as a static random access memory (SRAM), an electrically erasable programmable read-only memory (EEPROM), an erasable programmable read only memory (EPROM), a programmable read-only memory (PROM), a read-only memory (ROM), a magnetic memory, a flash memory, a magnetic disk, or an optical disk. The multimedia component 803 may include a screen and an audio component. The screen may be, for example, a touch screen, and the audio component is configured to output and/or input audio signals. For example, the audio component may include a microphone for receiving external audio signals. The received audio signal may further be stored in the memory 802 or transmitted through the communication component 805. The audio component further includes at least one speaker for outputting audio signals. The I/O interface 804 provides an interface between the processor 801 and other interface modules, such as a keyboard, a mouse, or buttons. These buttons may be virtual buttons or physical buttons. The communication component 805 is configured for wired or wireless communication between the permanent magnet track irregularity measuring device 800 and other devices. Wireless communication may include, for example, Wi-Fi, Bluetooth, Near Field Communication (NFC), 2G, 3G or 4G, or one or a combination thereof, so that the corresponding communication component 805 may include: a Wi-Fi module, a Bluetooth module, or an NFC module.

In an exemplary embodiment, the permanent magnet track irregularity measuring device 800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic components to perform the method for measuring irregularity of the permanent magnet track.

In another exemplary embodiment, a computer-readable storage medium is also provided, which includes program instructions, which when executed by a processor, implement the steps of the method for measuring irregularity of the permanent magnet track. For example, the computer-readable storage medium may be the memory 802 that includes program instructions executable by the processor 801 of the permanent magnet track irregularity measuring device 800 to perform and implement the method for measuring irregularity of the permanent magnet track.

### Embodiment 4

Corresponding to the foregoing method embodiment, a readable storage medium is also provided in this embodiment, and the readable storage medium described below and the method for measuring irregularity of the permanent magnet track described above may be referred to in correspondence.

A readable storage medium, on which a computer program is stored, which, when being executed by a processor, implements the steps in the method for measuring irregularity of the permanent magnet track according to the foregoing method embodiment.

The readable storage medium specifically is as follows: any readable storage medium that may store program code, such as a USB flash drive, a removable hard disk, a read-only memory (ROM), a random access memory (RAM), a magnetic disk, or an optical disc.

The above described contents are only preferred examples of the present application and are not intended to limit the present application. For those skilled in the art, the present application can be modified and varied. Any modification, equivalent replacement, improvement, or the like made without departing from the spirit and principle of the present application shall fall within the protection scope of the present application.

The above description is merely the specific embodiments of the present application, however, the protection scope of the present application is not limited thereto, and any modifications and substitutions that can be easily conceived by those skilled in the art within the technical scope disclosed by the present application shall fall within the protection scope of the present application. Therefore, the protection scope of the present application shall be subject to the protection scope of the claims.

1. An apparatus for measuring irregularity of a permanent magnet track, comprising:
a superconducting levitator, wherein the superconducting levitator is provided with a photoelectric sensor;
a Hall sensor assembly, wherein the Hall sensor assembly is arranged on the superconducting levitator, one end of the Hall sensor assembly extends toward the permanent magnet track to form a positioning end, a plurality of Hall sensors uniformly arranged at an identical interval distance along a width direction of the permanent magnet track are arranged on the positioning end, the plurality of Hall sensors and a bottom of a superconductor in the superconducting levitator are positioned on an identical horizontal plane, the photoelectric sensor is arranged on a side surface of the superconducting levitator far away from the Hall sensor assemblies by a clamp, and the photoelectric sensor is arranged opposite to the plurality of Hall sensor assemblies along a length direction of the permanent magnet track; and
an acceleration detection apparatus, wherein the acceleration detection apparatus is arranged on the superconducting levitator, the acceleration detection apparatus is arranged along the length direction of the permanent magnet track, one end of the acceleration detection apparatus extends toward the permanent magnet track to form a measuring end, and a height of the measuring end of the acceleration detection apparatus is consistent with a height of a center of mass of the superconducting levitator.

2. The apparatus for measuring irregularity of the permanent magnet track according to claim 1, wherein a plurality of acceleration detection apparatuses comprise a first acceleration sensor and a second acceleration sensor, the first acceleration sensor and the second acceleration sensor are arranged on a side surface of the superconducting levitator by a clamp, and the first acceleration sensor is arranged opposite to the second acceleration sensor in the width direction of the permanent magnet track.

3. The apparatus for measuring irregularity of the permanent magnet track according to claim 2, wherein a data acquisition card is arranged at a top of the superconducting levitator, and the data acquisition card is electrically connected to the first acceleration sensor, the second acceleration sensor, the plurality of Hall sensor assemblies, and the photoelectric sensor.

4. A method for measuring irregularity of a permanent magnet track, comprising the following steps:
collecting a time domain signal of a superconducting levitator during operation based on a Hall sensor assembly, an acceleration detection apparatus and a photoelectric sensor, wherein the time domain signal comprises a photoelectric signal, an acceleration time domain signal, and a magnetic field time domain signal;
processing the photoelectric signal based on a preset peak-finding method to obtain time-course information of peaks and troughs;
fitting the time-course information of peaks and troughs to obtain a real-time speed of the superconducting levitator;
converting the acceleration time domain signal and the magnetic field time domain signal according to the real-time speed of the superconducting levitator to obtain a spatial domain signal;
constructing the spatial domain signal and a preset magnetic position signal according to a preset Fourier integration method to obtain an equivalent geometric irregularity signal; and
performing spectral density fitting on the equivalent geometric irregularity signal according to a preset Fourier variation method to obtain an equivalent geometric irregularity fitting parameter of the permanent magnet track.

5. The method for measuring irregularity of the permanent magnet track according to claim 4, wherein the step of processing the photoelectric signal based on the preset peak-finding method to obtain the time-course information of peaks and troughs comprises:
performing low-pass filtering and noise reduction processing on the photoelectric signal to obtain a noise-reduced photoelectric signal;
performing peak finding processing on the noise-reduced photoelectric signal based on a preset multi-window spectrum peak recognition algorithm to obtain a plurality of highest peaks and a plurality of lowest peaks; and
constructing according to the plurality of highest peaks and the plurality of lowest peaks to obtain time-course information of each peak and trough.

6. The method for measuring irregularity of the permanent magnet track according to claim 5, wherein the step of fitting the time-course information of peaks and troughs to obtain the real-time speed of the superconducting levitator comprises:
arranging a plurality of ground optical targets on the permanent magnet track, and measuring a distance between the plurality of ground optical targets to obtain a spacing value of the plurality of ground optical targets;
extracting the time-course information of each peak and trough to obtain a running distance corresponding to a peak point;
fitting according to the spacing value of the plurality of ground optical targets and the running distance corresponding to the peak point to obtain a polynomial fitting function; and
performing derivation on the polynomial fitting function to obtain the real-time speed of the superconducting levitator.

7. The method for measuring irregularity of the permanent magnet track according to claim 4, wherein the preset magnetic position signals are preset magnetic position signals in different directions, and the step of constructing the spatial domain signal and the preset magnetic position signal according to the preset Fourier integration method to obtain the equivalent geometric irregularity signal comprises:
detecting the superconducting levitator based on a first acceleration sensor and a second acceleration sensor to obtain a first vector signal and a second vector signal;
constructing based on the first vector signal and the second vector signal to obtain a center of mass acceleration signal expression;
detecting the superconducting levitator through a Hall sensor to obtain a magnetic field signal value;
constructing according to the magnetic field signal value and preset magnetic position signals in different directions to obtain an absolute displacement signal; and
constructing the preset magnetic position signals in different directions based on the absolute displacement signal and the spatial domain signal to obtain an equivalent geometric irregularity signal.

8. The method for measuring irregularity of the permanent magnet track according to claim 7, wherein the preset magnetic position signals in different directions comprise a transverse magnetic position and a vertical magnetic position, and the step of constructing the preset magnetic position signals in the different directions based on the absolute displacement signal and the spatial domain signal to obtain the equivalent geometric irregularity signal comprises:
constructing the transverse magnetic position according to the absolute displacement signal and the spatial domain signal to obtain a transverse irregularity signal expression;
constructing the vertical magnetic position according to the absolute displacement signal and the spatial domain signal to obtain a vertical irregularity signal expression; and
constructing according to the transverse irregularity signal expression and the vertical irregularity signal expression to obtain the equivalent geometric irregularity signal.

9. The method for measuring irregularity of the permanent magnet track according to claim 8, wherein the step of performing the spectral density fitting on the equivalent geometric irregularity signal according to the preset Fourier variation method to obtain the equivalent geometric irregularity fitting parameter of the permanent magnet track comprises:
performing Fourier transform on the transverse irregularity signal expression to obtain a transverse equivalent geometric irregularity power spectral density;
performing Fourier transform on the vertical irregularity signal expression to obtain a vertical equivalent geometric irregularity power spectral density;
converting the transverse equivalent geometric irregularity power spectral density and the vertical equivalent geometric irregularity power spectral density based on a preset polynomial algorithm to obtain a fitted function of an equivalent geometric irregularity spatial domain power spectral density; and
fitting the fitted function of the equivalent geometric irregularity spatial domain power spectral density according to a preset orthogonal distance regression method to obtain an equivalent geometric irregularity fitting parameter of the permanent magnet track.
